(19) United States
(12) Patent Application Publication
(10) Pub. No.: US 2004/0212547 A1
(43) Pub. Date: Oct. 28, 2004

(54) System for maximizing space of display screen of electronic devices

(76) Inventors: Mark D. Adamski, Westfield, IN (US); Mona L. Toms, Carmel, IN (US); Randall W. Sencaj, Carmel, IN (US)

Correspondence Address: DELPHI TECHNOLOGIES, INC., M/C 480-410-202, PO BOX 5052, TROY, MI, 48007, US

(21) Appl. No.: 10/424,400

(22) Filed: Apr. 28, 2003

(51) Int. Cl. G09G 5/00

(52) U.S. Cl. 345/1.1

(57) ABSTRACT

The present invention provides a method for maximizing the use of a display screen space of an electronic device, such as a portable calculator or a mobile phone. The present invention involves providing a display screen electronically formatted to contain a plurality of multi-purpose fields that accommodates a variety of functions such as displaying operation or field labels, receiving data input, displaying data output, or facilitating editing. The present method allows the field labels to be replaced by data entry field, essentially by overwriting in the same screen area. The present invention further provides an electronic device capable of performing the method for maximizing the use of a display screen space described herein.

### BACKGROUND OF THE INVENTION

1. Field of the Invention

The field of the invention relates to systems for displaying text or data input/output information on a display screen of an electronic device, particularly a human machine interface (HMI) device.

2. Description of the Related Art

A human machine interface (HMI) electronic devices Such as a portable electronic calculator or a mobile phone have been adapted to accommodate various data input/output, both in text and numerical forms. Data input is generally difficult and time-consuming with mobile devices that have a small keyboard for data entry. This problem is compounded by the small display screen. The display screen of a typical small HMI device is formatted such that field labels are positioned in separate lines from the corresponding data entry field. This format protects the field label line and makes it impossible to enter data in the field label line. The user is forced to use additional lines for data entering, thus taking up valuable screen space. With a data entry application that has many fields (e.g. navigation destination entry), the user may then be required to scroll down to access the other fields that are not shown on the display screen (e.g., city and state fields). This type of small HMI devices generally results in unnecessary key presses and inconsequential information (i.e., labels) being displayed.

The usefulness of small HMI electronic devices is constrained by the limited display space of a small screen inherent in such small electronic devices.

### SUMMARY OF THE INVENTION

The present invention provides a method for maximizing the use of a display space of a display screen of electronic devices. The method is particularly useful in small electronic devices, such as a portable calculator or a mobile phone. Generally, the method involves providing a display screen that is electronically formatted to contain a plurality of multi-purpose fields that can accommodate a variety of functions such as describing, identifying or labeling an operation or a field, receiving data input, displaying data output, or facilitating editing.

In one aspect, the present invention provides an electronic device adapted to maximize use of the display screen space. The electronic comprises a display screen electronically formatted to contain a plurality of multi-purpose fields, and software operationally coupled with the screen and interfaced with a user to control the function of each multi-purpose field. Each of the multi-purpose fields can optionally display operation or field labels, receive data input, or display data output. The software may be adapted to enable the electronic device to store data in an electronic memory of the electronic device. The stored data may be retrieved and displayed in the multi-purpose fields of the screen of the present invention. The software may be further adapted to enable the electronic device to analyze the data and display the result of the analyzed data. The electronic device further comprises a data entry device, such as a keypad.

In another aspect of the present invention, the method for maximizing the screen space comprises the steps of displaying at least one field label at a predetermined portion of the screen, entering data corresponding to the field label at the predetermined portion of the screen, replacing the field label, and displaying the data at the predetermined portion of the screen. The method may further comprise the step of storing the data in an electronic memory of the electronic device, analyzing the data; and displaying an output corresponding to the analyzed data.

The method of the present invention reduces the space requirements to effectively enter data, reduces inconsequential information, reduces users interaction, and increases the lines of useful information displayed at once in a user friendly format.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIGS. 1A-1E show a typical HMI display according to prior art;

FIGS. 2A-2D show an HMI display according to one embodiment of the present invention;

FIGS. 3A-3E show an HMI display according to another embodiment of the present invention;

FIG. 4 shows a small electronic device of prior art;

FIG. 5 shows an embodiment of an electronic device of the present invention; and

FIG. 6 shows a flowchart of a method of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The embodiments disclosed below are not intended to be exhaustive or limit the invention to the precise form disclosed in the following detailed description. Rather, the embodiments are chosen and described so that others skilled in the art may utilize their teachings.

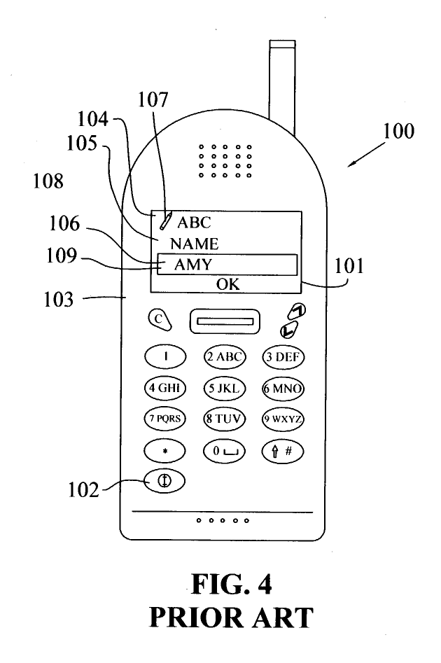

Generally a small or a hand-held HMI device such as a calculator or a mobile phone of prior art can perform a limited predetermined operations such as mathematical calculation, or creating an electronic address book. An example of a prior art hand-held telephone is demonstrated in FIG. 4. To start an operation of electronic device 100, a user activates a display screen 101 and selects a predetermined operation using conventional steps such as pressing power button 102 on keypad 103 and/or selecting from a series of operations indicated one at a time on screen 101. Display screen 101 of electronic device 100 generally contains one or more single-purpose fields. Each single-purpose field is adapted to exclusively perform a single function, i.e. field 104 for displaying an operation label 107, field 105 for displaying field label 108, and field 106 for entering data 109. Consequently, fields 104 and 105 will not permit data entering. Typically, more than half of a display screen is allocated to operation/field labels 104, 105, leaving very only field 109 for data entering. To complete a routine operation, such as recording an address, the user usually is required to scroll down the screen or update to a new display to find additional data entering fields.

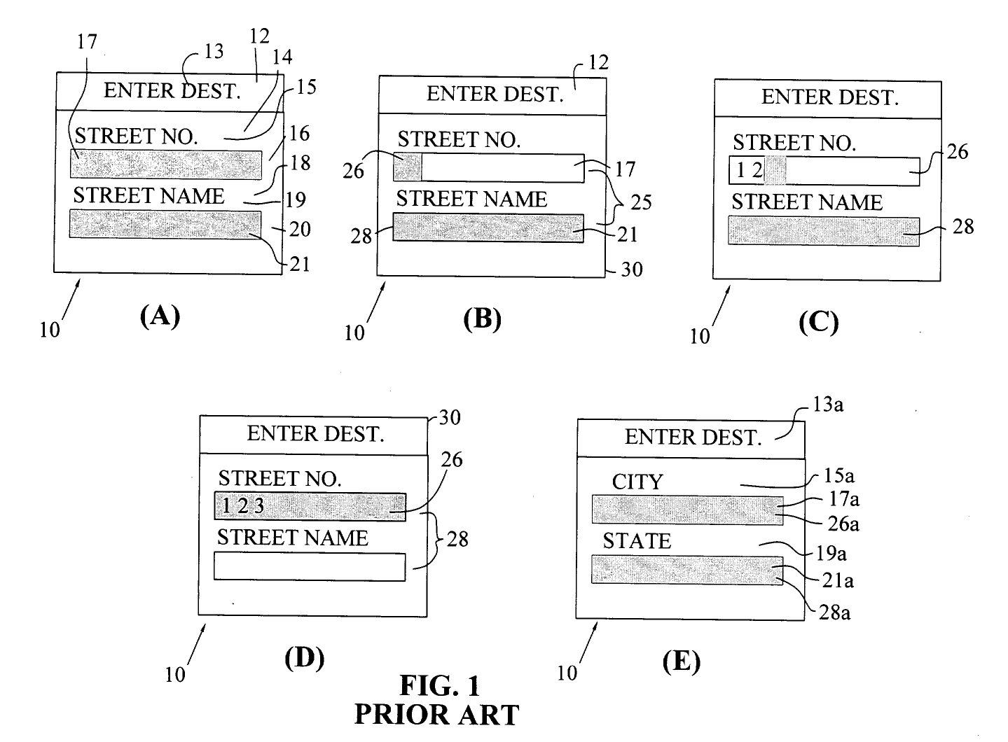

An example of how a prior art HMI display screen operates is represented in FIGS. 1A-1E. As shown, screen 10 shows five text lines 12, 14, 16, 18 and 20. First text line 12 contains an operation label 13, which reads “ENTER DEST.” indicating that the screen is ready for entering a destination or an address. Second text line 14 contains a field label 15, which reads “STREET NO.”, indicating that the field below calls for street number information. Third text line 16 contains data entering field 17 adapted to receive numeric text input associated with a street number. Fourth text line 18 contains field label 19, which reads “STREET NAME”, indicating the field below calls for street name information. Fifth text line 20 is adapted as data entering field 21 adapted for receiving text input associated with a street name.

In addition, as shown in FIGS. 1B-1D, data entering fields 17 and 21 are formatted to appear as rectangular boxes 26 and 28, having side buffers 25 between each of boxes 26 and 28 and side edges 30 of screen 10. This configuration is quite typical for prior art small electronic device having a small display screen.

According to a corresponding procedure, the user may select data entering field 17 and enter a numeric data corresponding to a street number as shown in FIGS. 1B-1C. After entering the street number information, the user may select data entering field 21 as shown in FIG. 1D, and enter text data corresponding to a street name. Since the operation of entering a destination is not complete, the user may select to update display screen 10 to display screen 10a, as shown in FIG. 1E. Updated display screen 10a may contain the operation label 13a, field label 15a, which reads “CITY”, and field label 19a, which reads “STATE”. Data entering field 17a in box 26a is adapted to receive data associated with a city name. Similarly, data entering field 21a in box 28a is adapted to receive the data corresponding to a State name. The user may enter the corresponding data in appropriate fields.

As demonstrated above, the display screen of prior art is not space efficient. In order to correct the deficiency, the present invention provides a method for maximizing the use of the screen space of electronic devices particularly small electronic devices. Also provided are electronic devices that can perform such method.

The method of the present invention generally involves providing a display screen formatted to contain a plurality of multi-purpose fields. The multi-purpose fields may be adapted to perform multiple functions, such as displaying field labels, receive input data, and display output information. With the multi-purpose fields, the user may replace field labels with data input/output, and display a full set of relevant information on one display screen, thus maximize the use of a limited screen space. The method of the present invention eliminates or minimizes the user's need to update or scroll down the display screen.

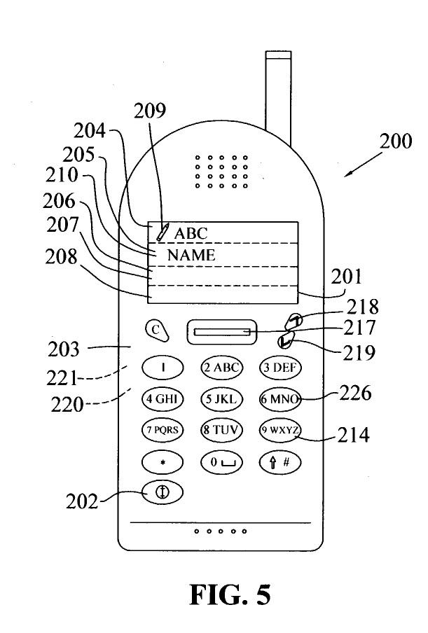

Referring now to FIG. 5, exemplary electronic device 200 of the present invention is shown. Although device 200 resembles a hand-held telephone, it is understood that the electronic device of the present invention may include any stationary or portable devices having a large screen or a small screen that utilize a field label format, as described herein above. The electronic device of the present invention may include, but not limited to, a personal digital assistant (PDA), a cellular phone, and a hand-held pervasive device that may have features for hooking up with a personal computer (PC). The electronic device, particularly a small device, has a display screen with limited numbers of text lines or data entry fields. The exemplary electronic device 200 has all the basic components and external features generally found in a typical hand-held telephone, such as power button 202 for turning electronic device 200 on/off, screen display 201, scroll up buttons 217 for enabling a user to scroll up the screen, scroll down button 219 for enabling a user to scroll down the screen, and enter bar 217 for entering a demand.

Electronic device 200 further includes software 220 operably coupled with display screen 201, and adapted to allow a user to control the function of display screen 201. Software 220 is also adapted to enable electronic device 200 to perform all functions of a typical telephone. Electronic device 200 may include electronic memory 221 for storing entered data, and a data entering device 224 which may include a traditional keypad 225 or a character recognition device operably coupled with an electronic pen for electronically writing on the screen 201, or a device for speech recognition.

Display screen 201 of electronic device 200 is adapted to contain a plurality of multi-purpose fields 204-208, each of which can be designed to display an operation label, a field label, receive data input, display data output, or perform any other related function such as facilitate editing.

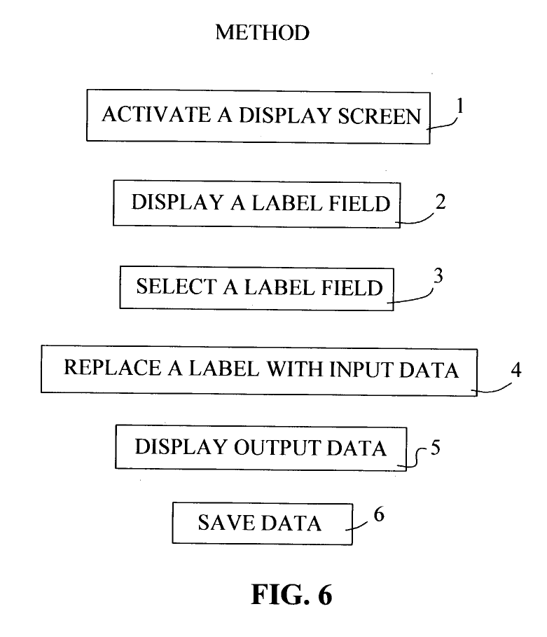

As shown in the flowchart in FIG. 6, a method of the present invention includes the following steps: 1) activating a display screen, 2) displaying at least one label field, 3) selecting the at least one label field, 4) replacing the label field with data input, and 5) displaying data input. The method of the present invention may additionally include the step of saving the data into the electronic memory of the electronic devices.

An example of the method of the present invention may be demonstrated using electronic device 200 in FIG. 5. First, display screen 201 may be activated by simply turning on electronic device 200. This step may be accomplished by simply pushing power button 202. After display screen 201 is activated, a menu of operations may be displayed. The user may select one operation from the menu. This step may be accomplished by any predetermined method known in the art. For example, a cursor may be placed on one operation name by using scrolling up or down buttons 218 or 219, and pressing bar 217 to enter the selection. After an operation is selected, display screen 201 may show a plurality of fields 204-208, each adapted to serve a plurality of purposes.

As shown in FIG. 5, the instance screen 201 displays an operation label 209 in field 204, field label 210 in field 205, and fields 206-208 are blank. The user now has options of selecting and entering data input in any one of fields 204-208. Data input may be accomplished by pressing on appropriate character buttons 226. Field label 210 or operation label 209 may be replaced by the data input.

Displaying data output is usually automatic and instantaneously with data entering. The saving step may be performed by pressing “save” or “enter” button 217, or by scrolling off of the data entered.

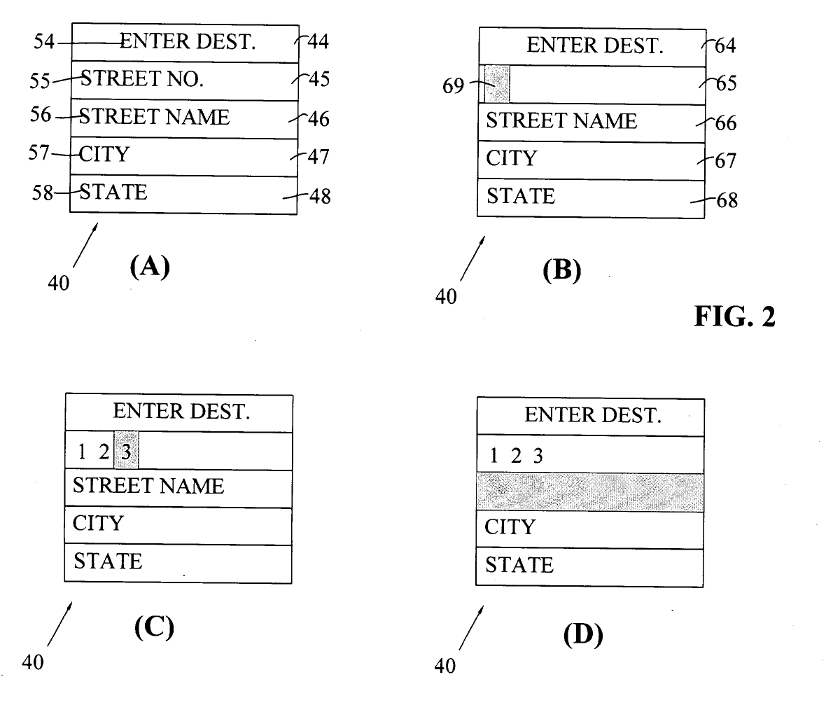

According to one specific example of the present invention, shown in FIGS. 2A-2D, display screen 40 shows five text lines 44-48. Text line 44 represents title field 64, and text lines 45-48 represent multi-purpose fields 65-68. According to FIG. 2A, text line 44 displays title 54 which reads “ENTER DEST”, text line 45 displays field label 55 that reads “STREET NO”, text line 46 displays field label 56 that reads “STREET NAME”, text line 47 displays field label 57 that reads “CITY”, and text line 48 displays field label 58 that reads “STATE”.

The user may replace each of field labels 55-58 with text input corresponding to the field labels. As shown in FIG. 2A-2B, field label 55 in multi-purpose field 65 is first selected for data entry. This step may be accomplished by any conventional HMI method such as moving a cursor over field label 55. This action causes the term “STREET NO.” to disappear, making multi-purpose field 65 available for data input. Alternatively, the term “STREET NO.” may appear altered, e.g. in bold, outline, or shadow, and overwritten by text input. Numerical text representing a street number may be entered as demonstrated in FIGS. 2C-2D. The user may continue to replace field labels 56-58 with text input associated with a street name, a city, and a State in fields 66-68, respectively. Alternatively, the user may enter the input data in front of “STREET NO.” pushing the word “STREET NO.” off the display screen. As a result, screen 40 displays a specific address as entered by the user. The entering and displaying of data may be accomplished without the need to scroll down display screen 40 or update the display.

Although not shown in FIGS. 2A-2D, it is also possible to replace title label 54 in title field 64 with text input if title field 64 is adapted to be a multi-purpose field capable of receiving data input. For example, title label 54 may display a field label that reads “NAME”, and adapted to receive text input representing a name of a person or a business. The user may be able to enter a name in title field 64, replacing the field label “NAME”. When data entering is complete, the field labels in all five text lines may be replaced with the input/output information.

Referring again to FIGS. 2A-2D, fields 45-48 may be configured to expand within a partial width or a full width of the display screen 40 in order to accommodate a desired number of characters or numbers of the input/output text or the field label.

In one aspect of the invention, other labels and associated data input/output may include a description related to telephone number, e-mail address, Uniform Resource Locator (URL), or numerical text representing mathematical calculation.

Referring back to FIG. 5, in another aspect, electronic device 200 of the present invention may further contain an electronic memory 221 in the form of a memory chip or disc or any other memory device for storing entered information. The information can be retrieved and displayed on the screen 201 of the present invention. For example, the name and corresponding address of a particular person may be stored and subsequently retrieved from an electronic address book of the electronic device. Editing may be made by replacing the displayed text with new text input.

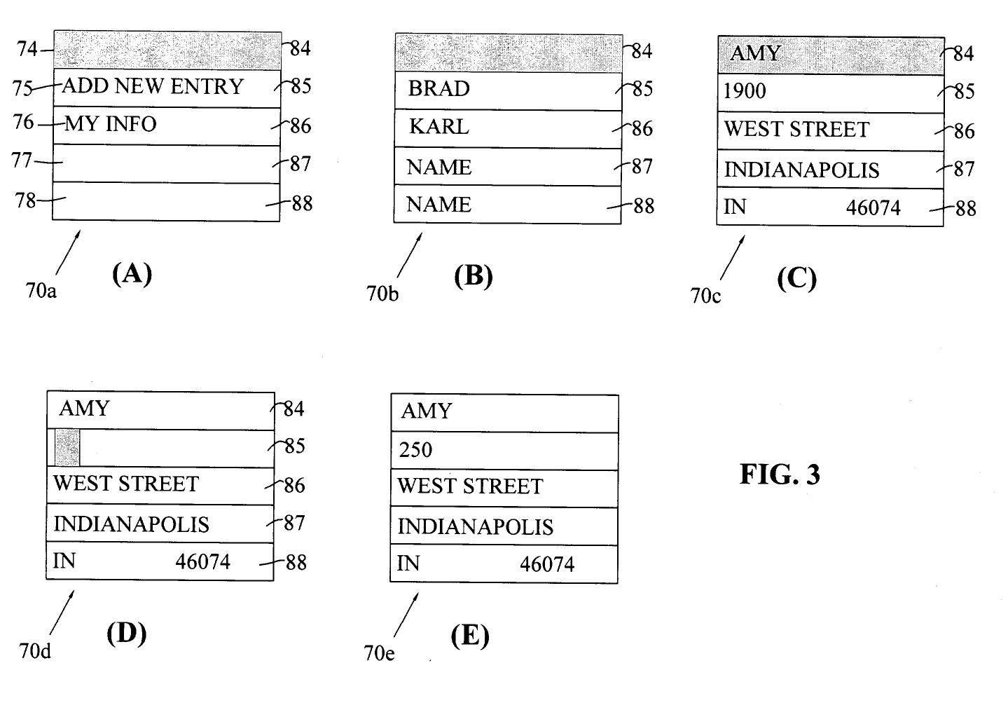

According to another specific example, as in FIGS. 3A-3E, the electronic device of the present invention comprises screen 70 formatted with five text lines 74-78. Each text line contains multi-purpose fields 84-88. Each multi-purpose field 84-88 is adapted to optionally perform any one of the following functions: displaying the options for predetermined operations (FIG. 3A), displaying retrieved text (FIGS. 3B-3C), receiving input text, and display output text (FIGS. 3D and 3E). When a user activates display screen 70, a list of a plurality of operation options may be displayed. Each option is displayed within one of multi-purpose fields 84-86 (FIG. 3A). Multi-purpose fields 87-88 display blank. In the case that the user further selects the operation “FIND NAME” in multi-purpose field 84 (FIG. 3A), screen 70 automatically switches to screen 70b (FIG. 3B), which displays a list of names retrieved from an electronic address book maintained electronically in the electronic device. Each name appears in each of multi-purpose fields 84-88. In the case that the user next selects the name “AMY” in multi-purpose field 84, the display screen automatically switches to display screen 70c (FIG. 3C), which displays the name “AMY” in multi-purpose field 84 and the associated address in multi-purpose fields 85-88. Next, the user may optionally select multi-purpose field 85 to update the street number information. The user may replace the displayed number with a new number in multi-purpose field 85 (FIG. 3D), so that a corrected street number can be displayed in multi-purpose field 85 (FIG. 3E).

Although a specific selection in a specific multi-purpose field is demonstrated, other selection in other multi-purpose field may operate in a similar manner. For example, as referring back to FIG. 3C, the name of the city in multi-purpose field 88 may be selected for editing. The word “Indianapolis” may be replaced with another city's name to reflect a correct address.

While the present invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for maximizing use of a display screen capable of displaying field labels in an electronic device comprising the steps of:
(a) displaying at least one field label at a predetermined portion of a screen of an electronic device;
(b) entering data entry at the predetermined portion of the display screen; and
(c) displaying the entered data at the predetermined portion of the screen.

2. The method of claim 1, further comprising the step of:
(d) storing the entered data into a database of the electronic device.

3. The method of claim 1, wherein said step of enabling data entry includes replacing the at least one field label at the predetermined portion of the screen.

4. The method of claim 1, wherein said displaying step includes displaying a plurality of field labels.

5. The method of claim 1, wherein said displaying step involves displaying information on the full screen.

6. The method of claim 1, wherein said displaying step involves displaying a description related to at least one of name, address, telephone number, e-mail address, Uniform Resource Locator (URL).

7. The method of claim 1, wherein said enabling data entry step includes entering data related to at least one of: name, address, telephone number, e-mail address, Uniform Resource Locator (URL).

8. The method of claim 1, wherein said enabling data entry step includes entering numerical information.

9. An electronic device comprising:
a data entry device;
a processor operationally coupled with said data entry device for processing entered data;
software operationally coupled with said processor; and
a display screen operationally coupled with said software, said software enabling maximizing use of said display screen according to a method comprising the steps of:
(a) displaying at least one field label at a predetermined portion of a screen of the electronic device;
(b) entering data entry at the predetermined portion of the display screen; and
(c) displaying the entered data at the predetermined portion of the screen.

10. The electronic device of claim 9, wherein said software enables the electronic device to store the entered data in an electronic memory of the electronic device, and retrieve the stored data for displaying on said screen.

11. The electronic device of claim 9 further comprises a data entering device.

12. The electronic device of claim 9, wherein said data entering device includes a key pad.

13. The electronic device of claim 9, wherein said software enables the displaying step to include displaying a plurality of field labels.

14. The electronic device of claim 9, wherein said software enables the displaying step to include displaying on a full screen.

15. The electronic device of claim 9, wherein the software enables the displaying step to include displaying a description related to at least one of: name, address, telephone number, e-mail address, Uniform Resource Locator (URL).

16. The electronic device of claim 9, wherein the software enables the entering step to include entering data comprising information related to at least one of: name, address, telephone number, e-mail address, Uniform Resource Locator (URL).

17. The electronic device of claim 9, wherein the software enables the entering step to include entering numerical information.

18. An electronic device having a maximized use of screen space comprising:
a display screen electronically formatted to contain a plurality of multi-purpose fields, each of said multi-purpose fields adapted to perform a plurality of functions; and
a user interface for entry of user instructions;
software operationally coupled with said display screen, said software being responsive to user instructions to direct each of multi-purpose fields to perform at least one of the plurality of functions.

19. The electronic device of claim 18, wherein each of said multi-purpose fields extends a full width of said display screen.

20. The electronic device of claim 18, wherein the plurality of functions includes at least one of: displaying an operation label, displaying a field label, receiving text input, displaying text output, displaying a text retrieved from an electronic memory, receiving edited text, and displaying a calculation result.

21. The electronic device of claim 18, wherein said user interface includes a keypad.
